(19) United States
(12) Patent Application Publication
(10) Pub. No.: US 2025/0246341 A1
(43) Pub. Date: Jul. 31, 2025

(54) INSULATING MEDIUM STRUCTURE AND HIGH-SPEED CABLE

(71) Applicant: TELCO SOURCE CONNECT LLC, Shenzhen (CN)

(72) Inventors: Dragon Yu, Shenzhen (CN); JUN LI, Shenzhen (CN); GUANGXIANG HU, Shenzhen (CN); LIBIN JIA, Shenzhen (CN); TIANCHAO LIU, Shenzhen (CN); SHUANGHONG TAN, Shenzhen (CN)

(21) Appl. No.: 18/949,813

(22) Filed: Nov. 15, 2024

(30) Foreign Application Priority Data
Jan. 26, 2024 (CN) 202420194700.8

(51) Int. Cl. H01B 7/02; H01B 7/04; H01B 7/18; H01B 11/00

(52) U.S. Cl. CPC H01B 7/02; H01B 11/002; H01B 7/04; H01B 7/18

(57) ABSTRACT

Disclosed are an insulating medium structure and a high-speed cable, the insulating medium structure includes an insulating medium body and pores, where the pores include a first pore and a second pore, a pair of the first pores are formed in the insulating medium body and arranged in an axially symmetric manner, and used for passing a pair of conductors as a differential pair; and at least three second pores are formed in the insulating medium body, and each of the second pores are arranged in an axially symmetric manner relative to a symmetry axis of the pair of the first pores. By preparing the insulating medium into a structure having pores, the insulating medium structure is conducive to ensuring the structural stability of the high-speed cable, thereby avoiding the problem of performance variation of the high-speed cable when being bent and twisted, and reducing signal transmission loss and attenuation.

### CROSS-REFERENCE TO RELATED APPLICATIONS

The application claims priority to Chinese Patent Application No.202420194700.8, filed on Jan. 26, 2024 which is hereby incorporated by reference in its entirety.

### TECHNICAL FIELD

The present disclosure relates to the field of signal transmission, and particularly relates to an insulating medium structure and a high-speed cable.

### BACKGROUND

A high-speed cable generally uses differential pairs for signal transmission, with a structure consisting of two conductors, which are coated with an insulating medium, and the insulating medium can be one layer, two layers or more layers.

As shown in FIG. 1, one high-speed cable 900 includes a pair of conductors 100 as a differential pair, each of the conductors 100 is coated with an insulating medium 300, and two ground wires 200 are symmetrically arranged outside the differential pair; the conductors 100 are coated with a shielding layer 400, the insulating medium 300, and the ground wires 200, the shielding layer 400 is coated with an outer jacket 500, that is, the outer jacket 500 is applied over the shielding layer 400, one gap 600 is formed between the two insulating mediums 300 inside the shielding layer 400, and the other gap 600 is formed between the insulating mediums 300 and the ground wires 200. The high-speed cable 900 has a single layer of the insulating medium. It can be understood that a structure of the high-speed cable 900 shown in FIG. 1 is a cross-sectional structure of the high-speed cable 900 in its extension direction, which is the same below and will not be further described herein.

Another high-speed cable 900 is shown in FIG. 2. Different from the high-speed cable 900 shown in FIG. 1, a shielding layer 400 is applied over conductors 100 and an insulating medium 300 but is not applied over ground wires 200, and the insulating medium 300 is arranged as a whole; and an interior of the shielding layer 400 is filled with, apart from the conductors 100, the insulating medium 300, no gap 600 is formed inside the shielding layer 400, and a gap 600 is formed outside the shielding layer 400, and between the shielding layer 400 and the ground wires 200. The high-speed cable 900 also has a single layer of insulating medium.

Yet another high-speed cable 900 is shown in FIG. 3. Different from the high-speed cable 900 shown in FIG. 2, an insulating medium 300 is composed of two layers, each conductor 100 is coated with a first insulating medium 310, the two first insulating mediums 310 are completely applied over a second insulating medium 320, the second insulating medium 320 is coated with a shielding layer 400, and an interior of the shielding layer 400 is filled with, apart from the conductor 100, the first insulating medium 310 and the second insulating medium 320. The high-speed cable 900 has two layers of insulating medium. A high-speed cable 900 with a plurality of layers of insulating mediums has a structure by analogy.

When a gap 600 is formed, that is, air exists, inside the shielding layer 400 of the high-speed cable 900, as shown in FIG. 1. Since air is a best transmission medium, signal transmission attenuation is small. However, a wire structure shown in FIG. 1 has a poor stability, and the transmission performance of the wire is prone to variation when it is bent and twisted. When the interior of the shielding layer 400 of the high-speed cable 900 is completely filled with the insulating medium 300, as shown in FIGS. 2 and 3, the high-speed cable 900 exhibits the optimal structural stability, but the signal transmission attenuation is significant.

Therefore, how to balance the structural stability of the high-speed cable and the signal transmission attenuation problem is an urgent technical problem to be solved.

### SUMMARY

In view of the foregoing defects, it is necessary to provide an insulating medium structure and a high-speed cable.

In one example, an insulating medium structure, including an insulating medium body and pores, where the pores are formed in the insulating medium body; and the pores include:
a first pore, with a number of a pair being formed in the insulating medium body and being arranged in an axially symmetric manner, and the pair of the first pores is used for passing a pair of conductors as a differential pair; and
a second pore, with a number of at least three being formed in the insulating medium body; and each of the second pores is arranged in an axially symmetric manner relative to a symmetry axis of the pair of the first pores.

In one of the examples, each of the second pores is evenly divided into two groups, and each group of the second pores is symmetrically distributed with a center of the first pore as a center; or
each of the second pores is evenly divided into three groups, and two groups of the second pores are symmetrically distributed with the center of the first pore as a center, and the other group of the second pores is arranged in an axially symmetric manner relative to the symmetry axis and/or evenly distributed on the symmetry axis; or
for the symmetry axis, the second pores located on the symmetry axis are arranged in an axially symmetric manner relative to the symmetry axis, and the second pores located on two sides of the symmetry axis are also arranged in an axially symmetric manner; or
cross sections of the second pores in an extension direction of the insulating medium body can be partially or completely circular, partially or completely elliptical, partially or completely regular polygonal.

In one of the examples, the insulating medium body is further provided with third pores, passing areas of the third pores are differently from those of the second pores, and each of the third pores is arranged in an axially symmetric manner relative to the symmetry axis.

In one of the examples, the insulating medium body is further provided with fourth pores, passing areas of the fourth pores are differently from those of the second pores and those of the third pores, and each of the fourth pores is arranged in an axially symmetric manner relative to the symmetry axis.

In one of the examples, the insulating medium body includes a first insulating medium and a second insulating medium, each of the first pores is coated with the first insulating medium; and the two first insulating mediums are completely coated with the second insulating medium; and
the first insulating medium is provided with the second pores.

In one of the examples, the insulating medium structure includes at least one of the following:
the second insulating medium is also provided with the second pores;
the first insulating medium is further provided with the third pores, passing areas of the third pores are differently from those of the second pores, and each of the third pores is arranged in an axially symmetric manner relative to the symmetry axis; and
the second insulating medium is further provided with the fourth pores, passing areas of the third pores are differently from those of the second pores, and each of the fourth pores is arranged in an axially symmetric manner relative to the symmetry axis.

In one of the examples, the insulating medium body includes the second insulating medium and a third insulating medium, and the third insulating medium is provided with the second pores; and
the second insulating medium is completely applied over the third insulating medium and outside the two first pores.

In one of the examples, the insulating medium body further includes a first insulating medium, each of the first pores is coated with the first insulating medium; and
the first insulating medium is completely applied over the third insulating medium and outside the two first pores; and alternatively, the third insulating medium is separated from the first insulating medium by the second insulating medium.

In one of the examples, the insulating medium body is arranged in an axially symmetric manner relative to the symmetry axis.

In one of the examples, a high-speed cable includes conductors, ground wires, a shielding layer, an outer jacket, and the insulating medium structure stated in any of the examples;
a pair of the conductors passes through a pair of first pores on the insulating medium structure in a one-to-one correspondence;
the insulating medium structure is coated with the shielding layer, and
the shielding layer and the ground wires are coated with the outer jacket.

The insulating medium structure is applied in the high-speed cable, and by preparing the insulating medium into a structure having pores, and the pores are arranged in an axially symmetric manner relative to a symmetry axis, it is conducive to ensuring the structural stability of the high-speed cable on the premises of guaranteeing the effective of signal transmission via the high-speed cable, thereby avoiding the problem of performance variation of the high-speed cable when it is bent and twisted, and it is further conducive to reducing signal transmission loss, thereby reducing a degree of signal transmission attenuation.

### BRIEF DESCRIPTION OF DRAWINGS

In order to more clearly illustrate technical solutions in the embodiments of the present disclosure or in the prior art, a brief introduction to the accompanying drawings required for the description of the embodiments or the prior art will be provided below. Obviously, the accompanying drawings in the following description are only some of the embodiments of the present disclosure, and those of ordinary skill in the art would also be able to derive other drawings from these drawings without making creative efforts.

FIG. 1 is one structural schematic diagram of a high-speed cable according to the prior art.

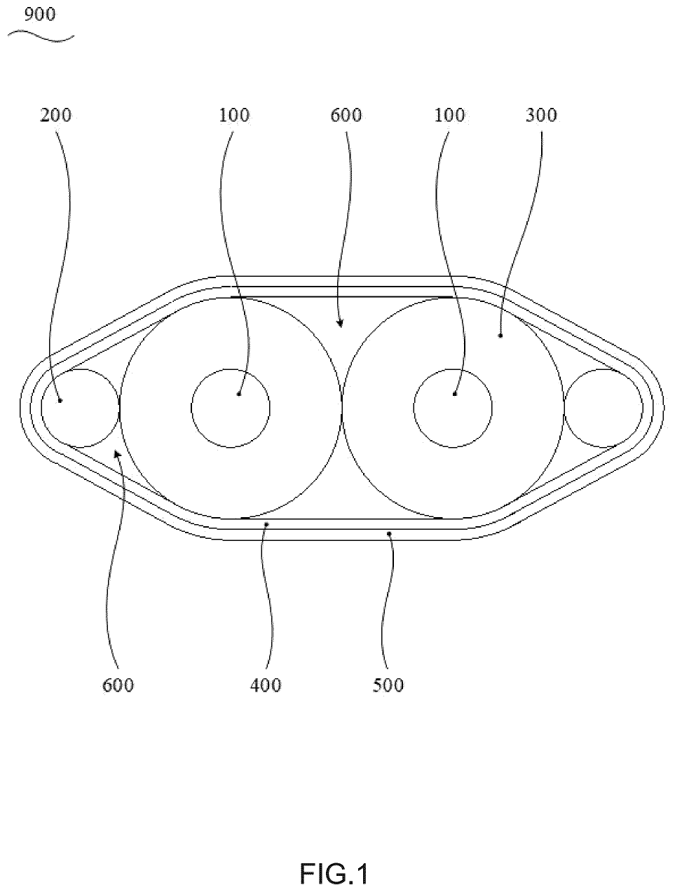

FIG. 2 is a structural schematic diagram of a high-speed cable according to the prior art.

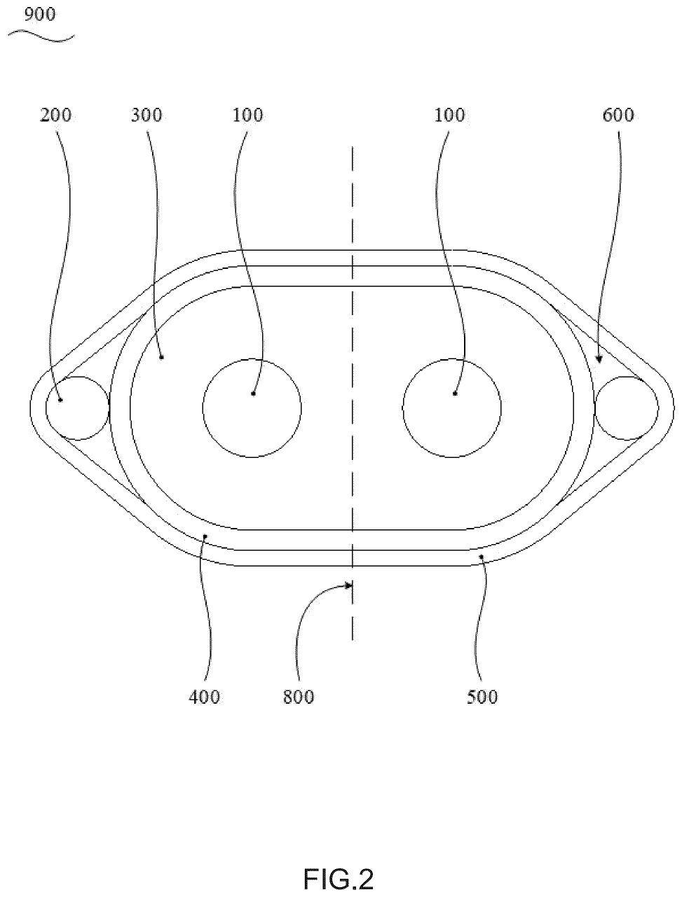

FIG. 3 is yet a structural schematic diagram of a high-speed cable according to the prior art.

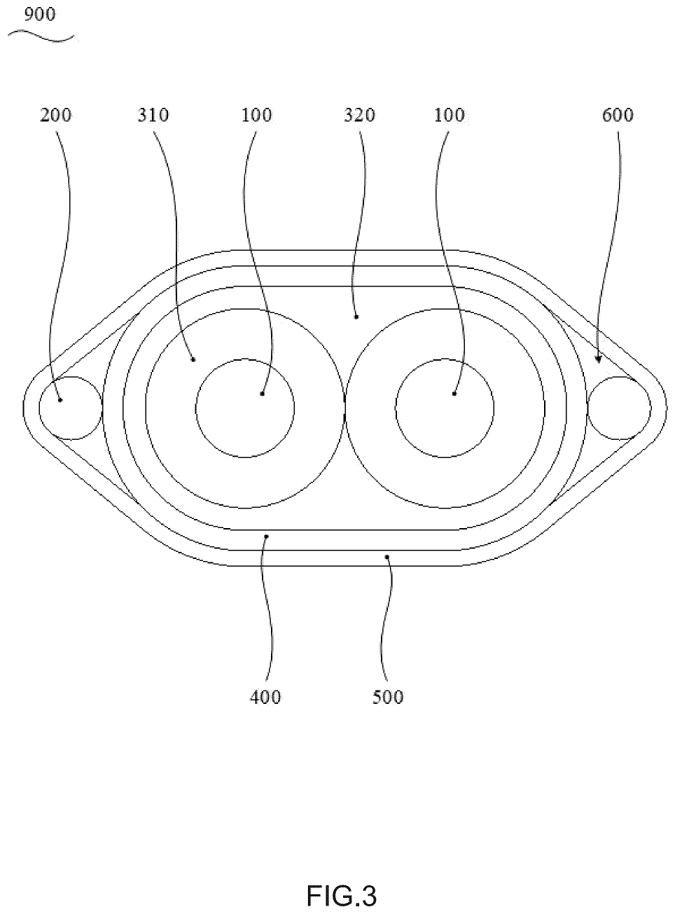

FIG. 4 is a structural schematic diagram of an insulating medium structure according to one example of the present disclosure.

FIG. 5 is a structural schematic diagram of a high-speed cable using the example shown in FIG. 4 according to one example of the present disclosure.

FIG. 6 is a structural schematic diagram of an insulating medium structure according to another example of the present disclosure.

FIG. 7 is a structural schematic diagram of a high-speed cable using the example shown in FIG. 6 according to another example of the present disclosure.

FIG. 8 is a structural schematic diagram of an insulating medium structure according to another example of the present disclosure.

FIG. 9 is a structural schematic diagram of a high-speed cable using the example shown in FIG. 8 according to another example of the present disclosure.

FIG. 10 is a structural schematic diagram of an insulating medium structure according to another example of the present disclosure.

FIG. 11 is a structural schematic diagram of a high-speed cable using the example shown in FIG. 10 according to another example of the present disclosure.

FIG. 12 is a structural schematic diagram of an insulating medium structure according to another example of the present disclosure.

FIG. 13 is a structural schematic diagram of a high-speed cable using the example shown in FIG. 12 according to another example of the present disclosure.

FIG. 14 is a structural schematic diagram of an insulating medium structure according to another example of the present disclosure.

FIG. 15 is a structural schematic diagram of a high-speed cable using the example shown in FIG. 14 according to another example of the present disclosure.

FIG. 16 is a structural schematic diagram of an insulating medium structure according to an example of the present disclosure.

FIG. 17 is a structural schematic diagram of a high-speed cable using the example shown in FIG. 16 according to another example of the present disclosure.

FIG. 18 is a structural schematic diagram of an insulating medium structure according to another example of the present disclosure.

FIG. 19 is a structural schematic diagram of a high-speed cable using the example shown in FIG. 18 according to another example of the present disclosure.

Reference numerals in the accompanying drawings: 100. conductor; 200. ground wire; 300. insulating medium; 301. first pore; 302. second pore; 303. third pore; 304. fourth pore; 305. insulating medium body; 310. first insulating medium; 320. second insulating medium; 330. third insulating medium; 400. shielding layer; 500. outer jacket; 600. gap; 700. insulating medium structure; 800. symmetry axis; and 900. high-speed cable.

### DETAILED DESCRIPTION OF THE EMBODIMENTS

In order to make the above objectives, features and advantages of the present disclosure more apparent and comprehensible, specific embodiments of the present disclosure will be described in detail below in conjunction with the accompanying drawings. Many specific details are set forth in the following description to facilitate thorough understanding of the present disclosure. However, the present disclosure may be implemented in many other ways different from those described herein, similar improvements may be made by those skilled in the art without departing from the connotation of the present disclosure, and therefore the present disclosure is not limited by the specific embodiments disclosed below.

It should be noted that if an element is considered to be “fixed to” or “arranged on” the other element, it means that the element may be directly on the other element or indirectly on the other element, or intervening elements may also be present. When an element is considered to be “connected” to another element, the element may be directly connected to another element or there may be an intermediate element simultaneously. The terms “vertical”, “horizontal”, “up”, “down”, “left”, “right”, and the like as used herein are for illustrative purposes only and do not represent the only embodiments.

Furthermore, the terms “first” and “second” are merely for the purpose of description, and cannot be construed as indicating or implying relative importance or implicitly specifying the number of technical features indicated. Thus, a feature defined with “first” and “second” may explicitly or implicitly include at least one of the features. In the description of the present disclosure, “a plurality of” means at least two, such as two, three, unless otherwise expressly and specifically defined.

In the description of the present disclosure, unless expressly specified and limited otherwise, a first feature being “on” or “under” a second feature may mean that the first feature makes direct contact with the second feature or that the first feature makes indirect contact with the second feature by means of an intermediary medium. Further, a first feature being “over”, “above” and “on” a second feature may mean that the first feature is directly above or obliquely above the second feature, or simply mean that the first feature is higher than the second feature. A first feature being “below”, “under,” and “beneath” a second feature may mean that the first feature is directly below or diagonally below the second feature, or simply mean that the first feature is lower than the second feature.

Unless otherwise defined, all technical and scientific terms mentioned in the specification of the present disclosure have the same meaning as commonly understood by those skilled in the technical field of the present disclosure. Terms mentioned in the description of the present disclosure are used only for the purpose of describing specific embodiments, and are not intended to limit the present disclosure. As used in the specification of the present disclosure, the term “and/or” includes any and all combinations of one or more relevant listed items.

The present disclosure provides an insulating medium structure and a high-speed cable, which includes some or all of the technical features of the examples described below, that is,
the insulating medium structure and the high-speed cable include some or all of the following structures. In one example of the present disclosure, an insulating medium structure includes an insulating medium body and pores, where the pores are formed in the insulating medium body; the pores include a first pore, a pair of the first pores are formed in the insulating medium body and are arranged in an axially symmetric manner, and the pair of the first pores is used for passing a pair of conductors as a differential pair; a second pore, and at least three second pores are provided and are formed in the insulating medium body; and each of the second pores are arranged in an axially symmetric manner relative to a symmetry axis of the pair of the first pores. The insulating medium structure is applied in the high-speed cable, and by preparing the insulating medium into a structure having pores, and the pores are arranged in an axially symmetric manner relative to the symmetry axis, it is conducive to ensuring the structural stability of the high-speed cable on the premises of guaranteeing the effective of signal transmission via the high-speed cable, thereby avoiding the problem of performance variation of the high-speed cable when it is bent and twisted, and it is further conducive to reducing signal transmission loss, thereby reducing a degree of signal transmission attenuation.

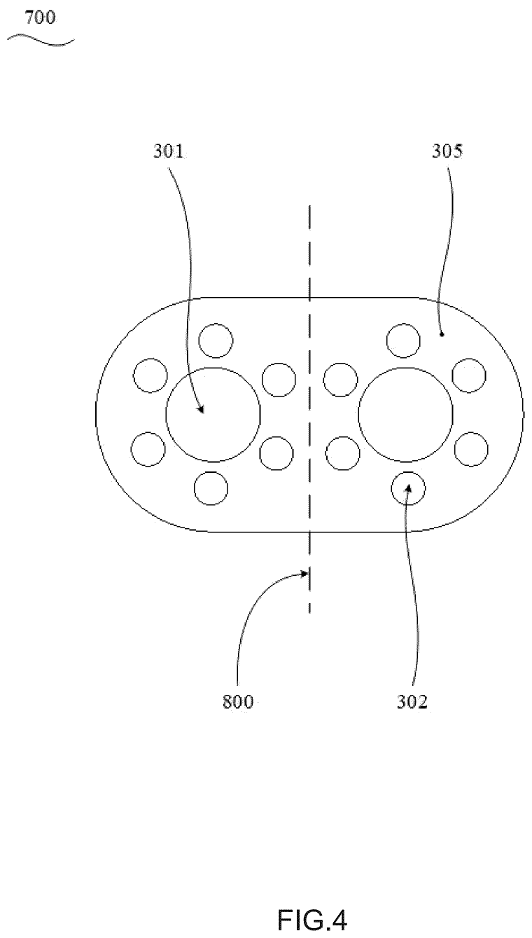

The insulating medium structure and the high-speed cable will be described below in conjunction with FIGS. 4-19.

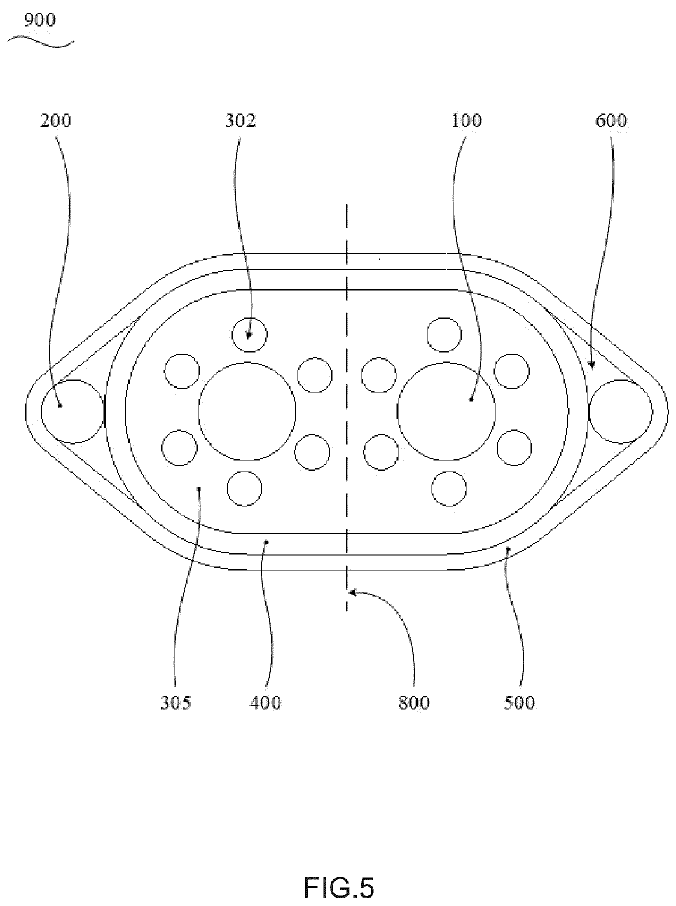

In order to solve the problem of how to balance the structural stability of the high-speed cable with the signal transmission attenuation problem, in one example, an insulating medium structure 700, as shown in FIG. 4, can be applied to the high-speed cable; specifically, the high-speed cable 900 shown in FIG. 5 uses the insulating medium structure 700 shown in FIG. 4. The present disclosure provides the high-speed cable 900 that adopts a structure similar to a lotus root core as the insulating medium structure 700. The significant distinction from the prior art is that the insulating medium structure 700 is a structure having pores and can be applied to the high-speed cable 900, that is, the insulating medium can be made into a lotus root core structure with a plurality of circular or other shaped holes inside, which cannot only make an interior filled with a large amount of air, but also guarantee an overall sufficient mechanical strength, such that wires when being bent and twisted will not suffer performance variations, thereby effectively solving the above problems.

With reference to FIGS. 4 and 5, in this example, the high-speed cable 900 includes conductors 100, ground wires 200, a shielding layer 400, an outer jacket 500, and the insulating medium structure 700; a pair of the conductors 100 passes through a pair of first pores 301 on the insulating medium structure 700 in a one-to-one correspondence; and the insulating medium structure 700 is coated with the shielding layer 400, and the shielding layer 400 and the ground wires 200 are coated with the outer jacket 500. The shielding layer 400 includes but is not limited to a metal shielding layer; and the outer jacket 500 can also be referred to as an outer jacket layer. A gap 600 is formed between the shielding layer 400 and the insulating medium structure 700; or as shown in FIG. 5, the shielding layer 400 tightly covers the insulating medium structure 700, that is, no gap 600 is formed between the shielding layer 400 and the insulating medium structure 700. The high-speed cable 900 adopts the insulating medium structure 700, similarly by preparing an insulating medium into a structure having pores, and the pores are arranged in an axially symmetric manner relative to a symmetry axis 800, it is conducive to ensuring the structural stability of the high-speed cable 900 on the premises of guaranteeing the effective of signal transmission via the high-speed cable 900, thereby avoiding the problem of performance variation of the high-speed cable 900 when it is bent and twisted, and it is further conducive to reducing signal transmission loss, thereby reducing a degree of signal transmission attenuation.

For the high-speed cable 900, a number of the conductors 100 is two, which is also referred to as two strands, each strand of the conductors 100 is a single metal wire or a plurality of meal wires, the metal wire is any one of silver-plated copper conductor, tin-plated copper conductor, bare copper conductor, silver-plated copper-clad steel conductor and silver-plated copper-clad aluminum conductor, and a cross-sectional shape of the metal wire can be circular, elliptical, flat, or any other shapes. It can be understood that for the differential pair, the pair of conductors 100 is symmetrically arranged in an extension direction of the high-speed cable 900. FIG. 5 is a cross-section in the extension direction of the high-speed cable 900, and in the extension direction, the pair of conductors 100 have the symmetry axis 800, which can also be understood as the pair of the first pores 301 having the symmetry axis 800. The other examples are analogous, and the high-speed cable 900 includes the insulating medium structure 700 described in any examples of the present disclosure, which will not be described in detail below.

With reference to FIGS. 4 and 5, in one of the examples, the insulating medium structure 700 includes an insulating medium body 305 and the pores, and the pores are formed in the insulating medium body 305; and the insulating medium body 305 is coated around the conductor 100, and the insulating medium body 305 is made from any one of polyethylene, polypropylene, fluorinated ethylene propylene, polytetrafluoroethylene, polyvinylidene fluoride or other fluoroplastics. The insulating medium body 305 is a single layer of insulating medium, or can also include two or more layers of different insulating mediums. The insulating medium body 305 has a plurality of hollow holes as the pores, the hollow holes can be circular, square, or other shapes, and are generally distributed in the cross-section of the insulating medium body 305 in a lotus root core shape, and the lotus root holes are symmetrically arranged. The structural design makes the insulating medium structure 700 into a lotus root core structure, such that an entire wire of the high-speed cable 900 can ensure sufficient mechanical strength and resistance to bending and twisting while improving the anti-attenuation performance.

In each of the examples, the pores include the first pores 301 and the second pores 302, and shapes and sizes of the first pores 301 and the second pores 302 can be set to be the same or different. In this example, the insulating medium body 305 is arranged in an axially symmetric manner relative to the symmetry axis 800. Illustratively, as shown in FIGS. 4 and 5, the first pores 301 and the second pores 302 have the same shape, and areas of the first pores 301 are larger than those of the second pores 302. It can be understood that in each example, the shape, area and the like are based on the cross section in the extension direction of the high-speed cable 900, and the other examples are analogous and will not be described in detail herein.

In order to facilitate differential signal transmission, in each of the examples, a number of the first pores 301 is a pair, which is formed in the insulating medium body 305 in an axially symmetric manner, the pair of the first pores 301 are used to pass the pair of conductors 100 as the differential pair; and as described above, the symmetry axis 800 of the pair of the first pores 301 is also the symmetry axis 800 of the pair of conductors 100. It should be noted that the above description is based on the structure of the insulating medium structure 700, and in an actual production process, the first pores 301 can be structures formed by the production process. Illustratively, the insulating medium body 305 can be filled around the conductors 100, covered around the conductor 100, or wound around the conductors 100, such that the conductors 100 are coated with the insulating medium body 305, spaces filled with the conductors 100 in the insulating medium body 305 are formed, and the space are used as the first pores 301. Illustratively, a tubular body, such as a hollow tube, is first preset at the second pores 302, and the tubular body can be extruded or extracted after the insulating medium body 305 is formed to form the second pores 302.

In order to make an internal structure of the insulating medium structure 700 contain air, in each of the examples, a number of the second pores 302 is at least three, which are formed in the insulating medium body 305; and each of the second pores 302 is arranged in an axially symmetric manner relative to the symmetry axis 800 of the pair of the first pores 301. The structural design can ensure that the internal structure of the insulating medium structure 700 contains air, which is conducive to reducing signal transmission loss, thereby reducing a degree of signal transmission attenuation.

In each of the examples, the shapes and sizes of the first pores 301 along the cross section in extension direction of the high-speed cable 900 are defined according to the conductors 100, the second pores 302 are one or all of at least partially circular, at least partially elliptical, at least partially regular polygonal, that is, cross sections of the second pores 302 in an extension direction of the insulating medium body 305 can be partially or completely circular, partially or completely elliptical, partially or completely regular polygonal; and that is, the cross sections of the second pores 302 can be a combination of partially circular, partially elliptical and/or partially regular polygonal. The structural design also aims to ensure that the internal structure of the insulating medium structure 700 contains air, which is conducive to reducing signal transmission loss, thereby reducing a degree of signal transmission attenuation.

In order to facilitate differential signal transmission, in one of the examples, each of the second pores 302 is evenly divided into two groups, and each group of the second pores 302 is symmetrically distributed with a center of the first pore 301 as a center; that is, for examples where the second pores 302 are not arranged on the symmetry axis 800, the number of the second pores 302 is an even number, such that each of the second pores 302 is arranged in an axially symmetric manner relative to the symmetry axis 800. In the examples shown in FIGS. 4 and 5, the number of the second pores 302 is twelve, which are divided into two groups arranged symmetrically relative to the symmetry axis 800, and each group contains six second pores 302 that are symmetrically distributed with the center of the first pore 301 as a center. It can be understood that a specific number of the second pores 302 in the above examples is merely an example and should not be construed as an additional limitation to the present disclosure, which will not be described in detail below.

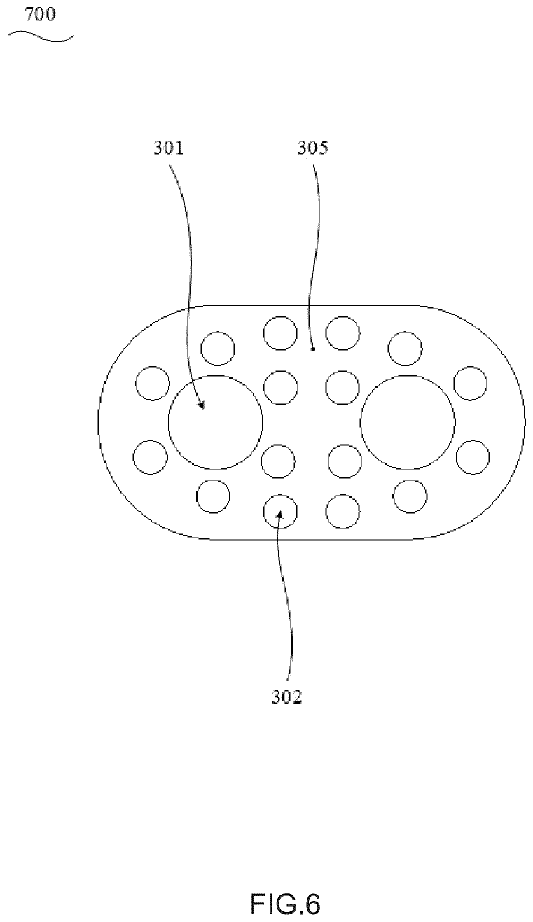

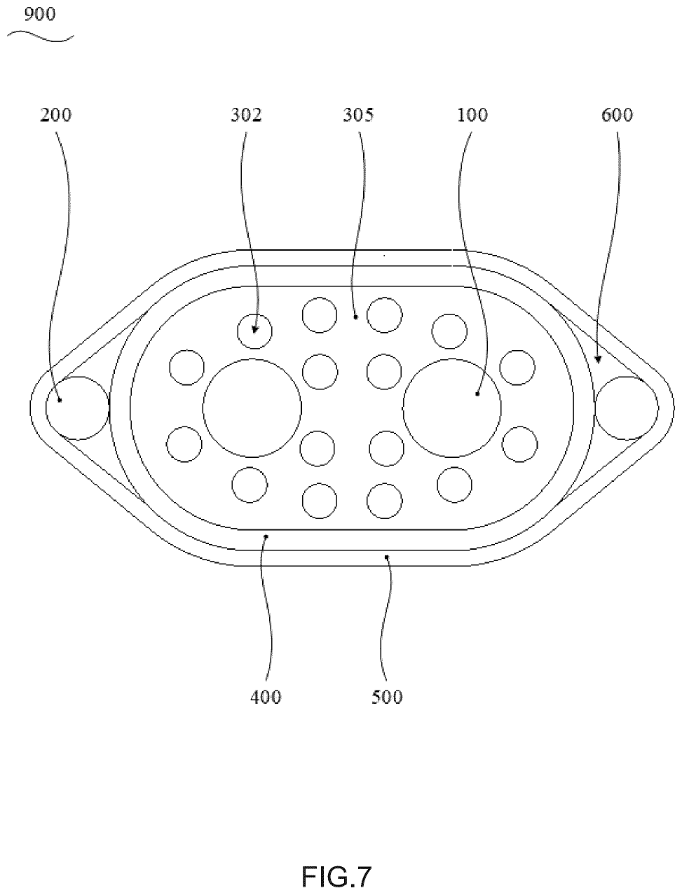

In order to facilitate differential signal transmission, in one of the examples, each of the second pores 302 is evenly divided into three groups, and two groups of the second pores 302 are symmetrically distributed with the center of the first pore 301 as a center; that is, the other group of the second pores 302 is arranged in an axially symmetric manner relative to the symmetry axis 800, that is, they are evenly distributed on the symmetry axis 800. In one of the examples shown in FIGS. 6 and 7, the number of the second pores 302 is sixteen, which are divided into three groups arranged symmetrically relative to the symmetry axis 800, each group of two groups contains six second pores 302, which take the center of one of the first pore 301 as a symmetry center and is centrally symmetrically distributed; and the other group of four second pores 302 are arranged in an axially symmetric manner relative to the symmetry axis 800.

In order to further facilitate differential signal transmission, in one of the examples, as shown in FIGS. 6 and 7, for the symmetry axis 800, the second pores 302 located on the symmetry axis 800 are arranged in an axially symmetric manner relative to the symmetry axis 800, and the second pores 302 located on two sides of the symmetry axis 800 are also arranged in an axially symmetric manner; that is, the second pores 302 can also be arranged on the symmetry axis 800, in which case, the second pores 302 themselves are axially symmetric in shape, and the second pores 302 are arranged in an axially symmetric manner relative to the symmetry axis 800.

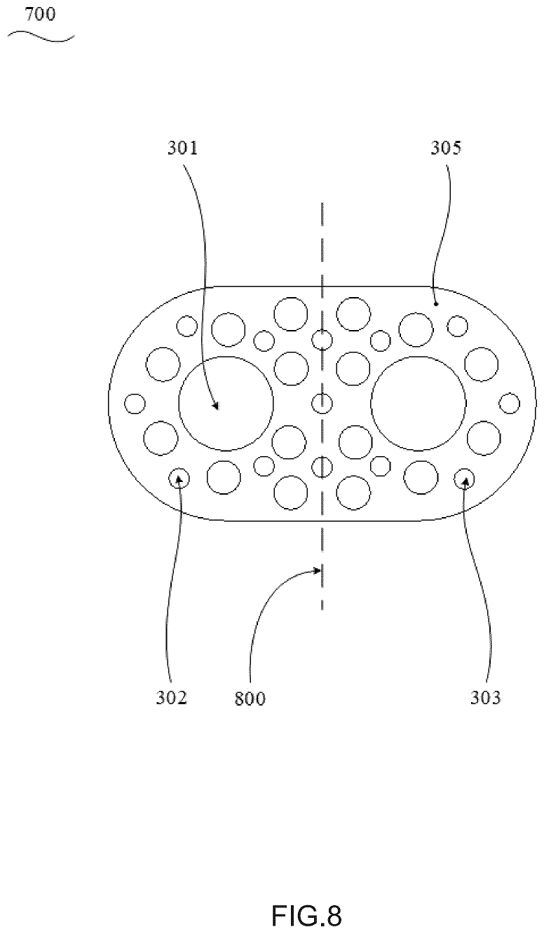

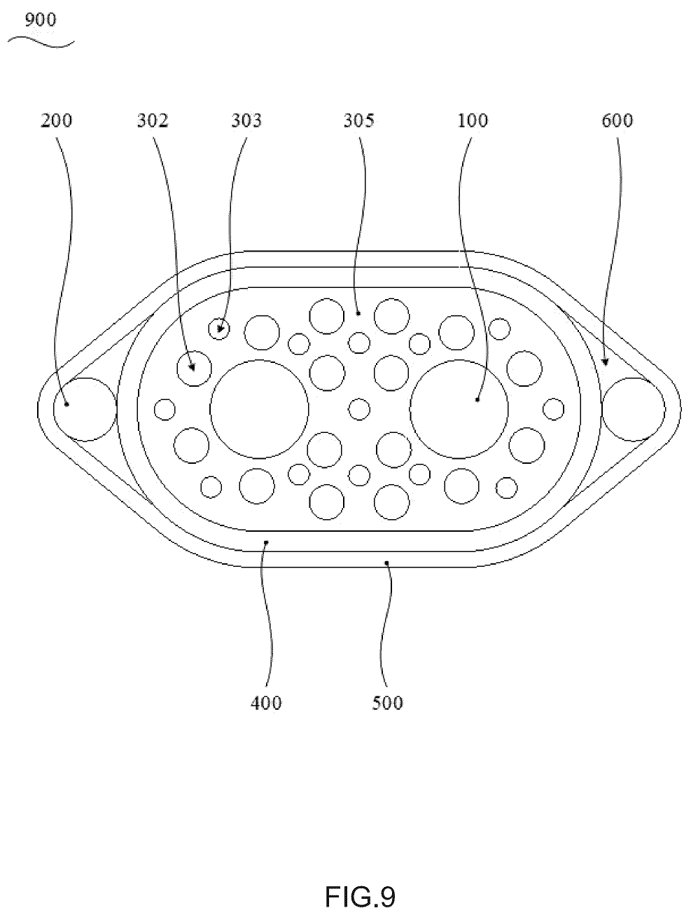

In order to further increase an air volume of the internal structure of the insulating medium structure 700, in one of the examples, the insulating medium body 305 is further provided with third pores 303, passing areas of the third pores 303 are differently from those of the second pores 302, and each of the third pores 303 is arranged in an axially symmetric manner relative to the symmetry axis 800. In one of the examples, the insulating medium structure 700 is shown in FIG. 8, and the high-speed cable 900 using the insulating medium structure 700 shown in FIG. 8 is shown in FIG. 9. Different from the examples shown in FIGS. 6 and 7, the insulating medium body 305 is further provided with thirteen third pores 303, the thirteen third pores 303 are divided into three groups, among two of the groups, each group contains five third pores 303 that are arranged in an axially symmetric manner relative to the symmetry axis 800; and three third pores 303 in the other group are evenly distributed on the symmetry axis 800, and the third pores 303 themselves are arranged in an axially symmetric manner relative to the symmetry axis 800. The structural design further ensures that the internal structure of the insulating medium structure 700 contains a large amount of air, which is conducive to not only reducing signal transmission loss, thereby reducing a degree of signal transmission attenuation, but also ensuring the structural stability of the high-speed cable on the premises of guaranteeing the effective of signal transmission via the high-speed cable, thereby avoiding the problem of performance variation of the high-speed cable when it is bent and twisted.

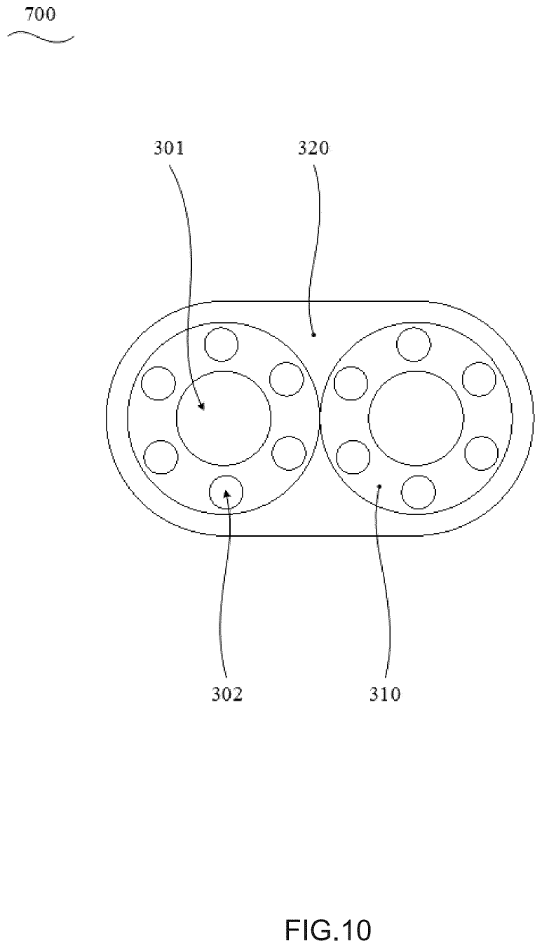

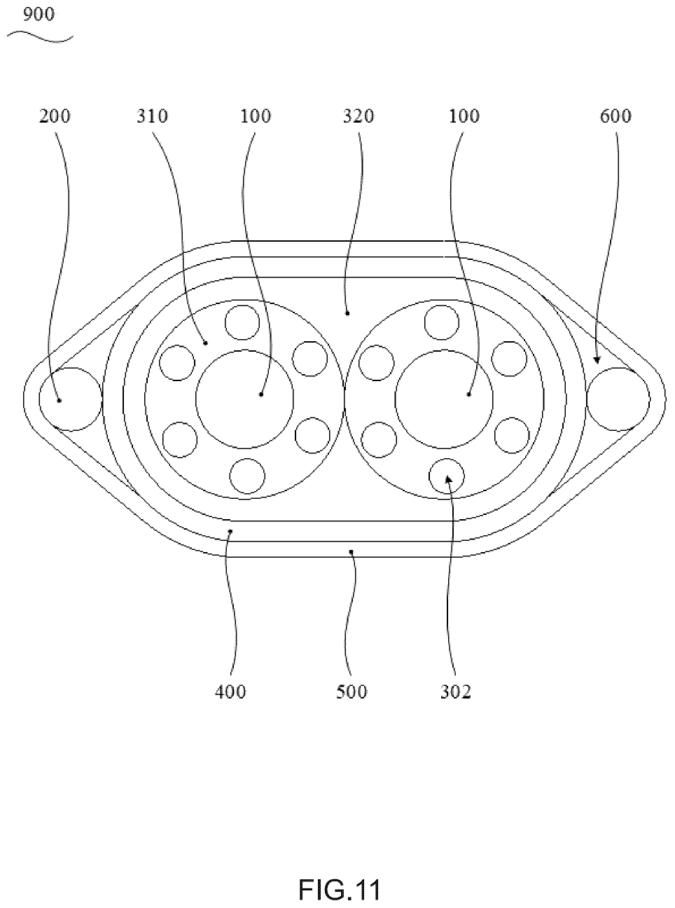

In the examples shown in FIGS. 4-9, the insulating medium structure 700 has only one layer of insulating medium; in one of the examples, the insulating medium structure 700 is shown in FIG. 10, and the high-speed cable 900 using the insulating medium structure 700 shown in FIG. 10 is shown in FIG. 11. The insulating medium body 305 includes a first insulating medium 310 and a second insulating medium 320, which can also be understood as the insulating medium body 305 being divided into the first insulating medium 310 and the second insulating medium 320; each of the first pores 301 is coated with the first insulating medium 310, and the two first insulating mediums 310 are completely coated with the second insulating medium 320; and the first insulating medium 310 is provided with the second pores 302. Materials of the first insulating medium 310 and the second insulating medium 320 can be the same or different. In the examples where the materials of the first insulating medium 310 and the second insulating medium 320 are the same, a preset process can be used to implement in sequence, and a implementation mode of the first insulating medium 310, the second insulating medium 320, and a third insulating medium 330 to be described below falls within the scope of prior art, to which no additional limitations will be imposed in the examples of the present disclosure. The structural design can also make the internal structure of the insulating medium structure 700 contained a large amount of air.

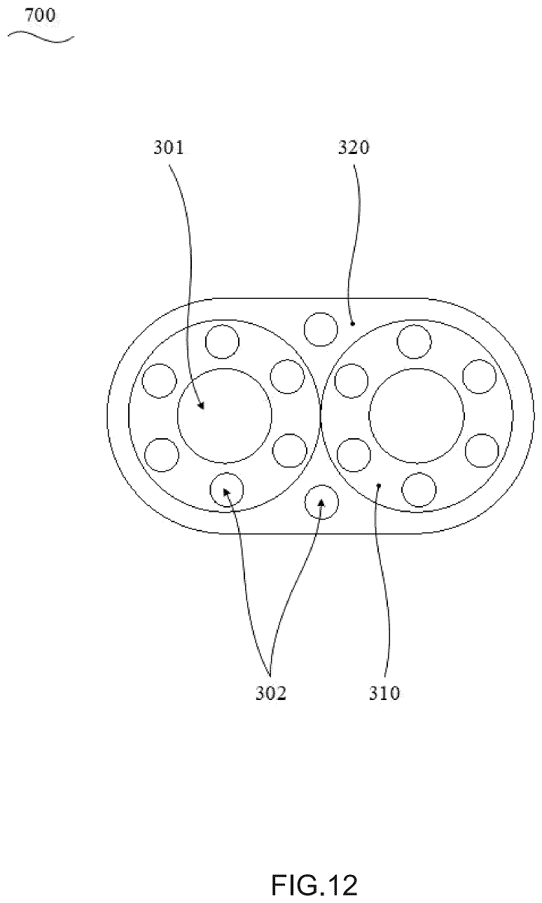

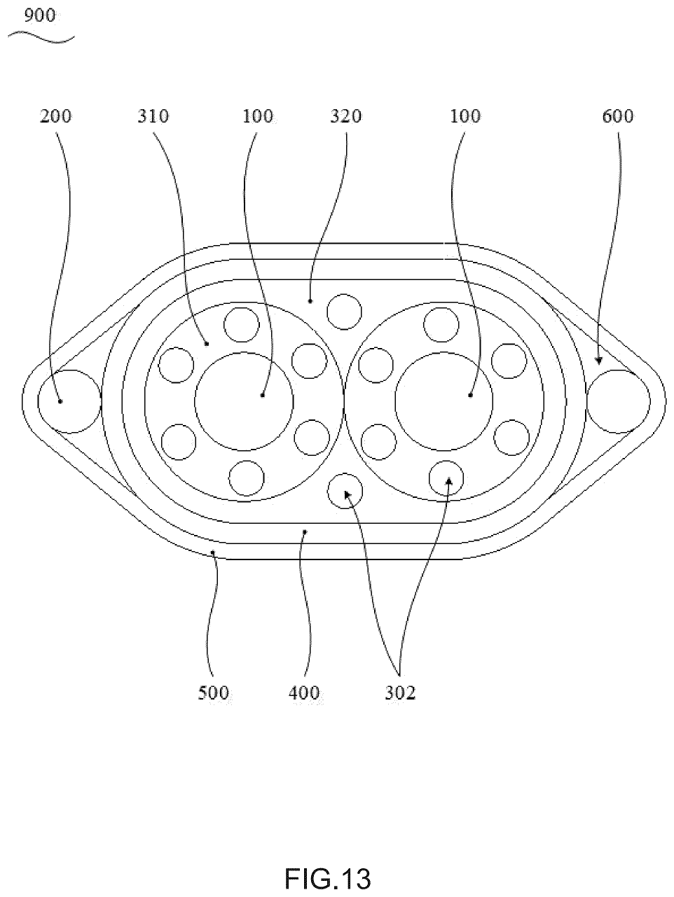

In the examples shown in FIGS. 10 and 11, the second pores 302 are only arranged in the first insulating medium 310; and in other examples, as shown in FIGS. 12 and 13, the second insulating medium 320 is also provided with the second pores 302. In this example, the second pores 302 in the second insulating medium 320 are evenly distributed on the symmetry axis 800, and the second pores 302 in the second insulating medium 320 are arranged in an axially symmetric manner relative to the symmetry axis 800. The structural design is conducive to increasing air content of the internal structure of the insulating medium structure 700.

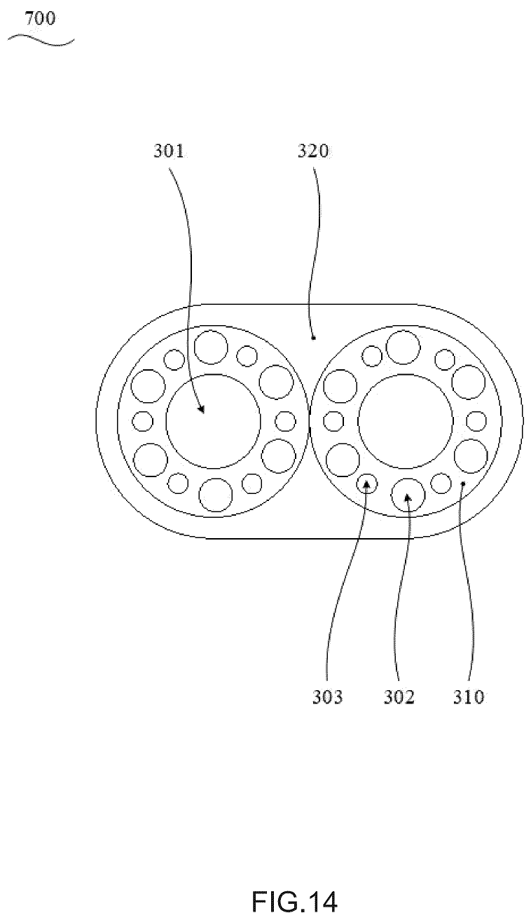

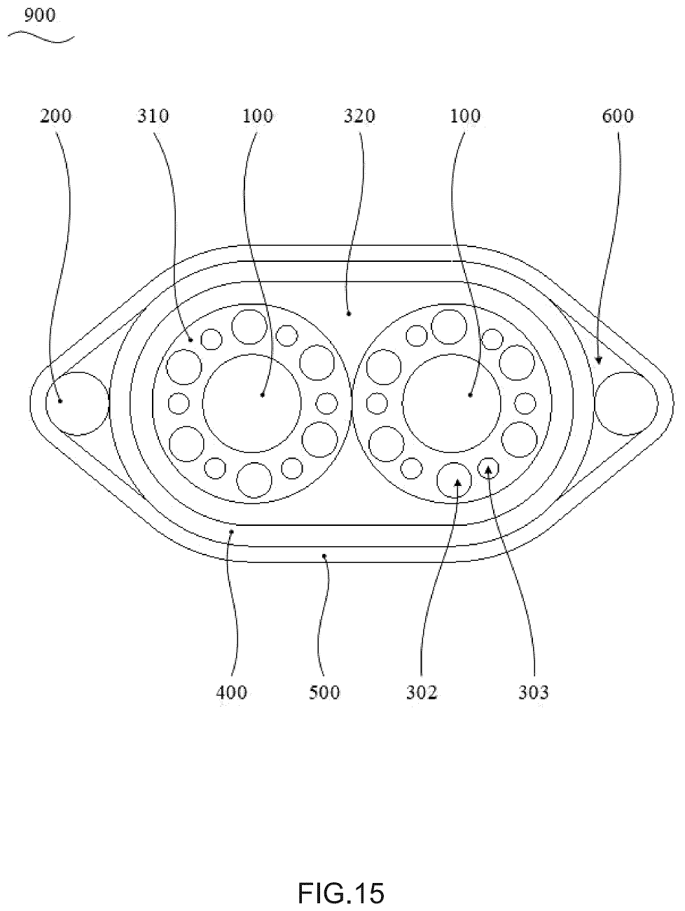

In one of the examples, the insulating medium structure 700 is shown in FIG. 14, and the high-speed cable 900 using the insulating medium structure 700 shown in FIG. 14 is shown in FIG. 15. The first insulating medium 310 is further provided with the third pores 303, the passing areas of the third pores 303 are differently from those of the second pores 302, and each of the third pores 303 is arranged in an axially symmetric manner relative to the symmetry axis 800. The structural design further increase the air content in the internal structure of the insulating medium structure 700, which is conducive to reducing signal transmission loss, thereby reducing a degree of signal transmission attenuation, such that the effectiveness of signal transmission in the high-speed cable is ensured, and a signal transmission distance of the high-speed cable can be improved.

In one of the examples, the insulating medium body 305 is further provided with fourth pores 304, passing areas of the fourth pores 304 are differently from those of the second pores 302 and those of the third pores 303, and each of the fourth pores 304 is arranged in an axially symmetric manner relative to the symmetry axis 800. The structural design can form more densely distributed air channels while ensuring the structural stability of the high-speed cable, such that the internal structure of the insulating medium structure 700 contains a large amount of air, which is conducive to reducing signal transmission loss, thereby reducing a degree of signal transmission attenuation.

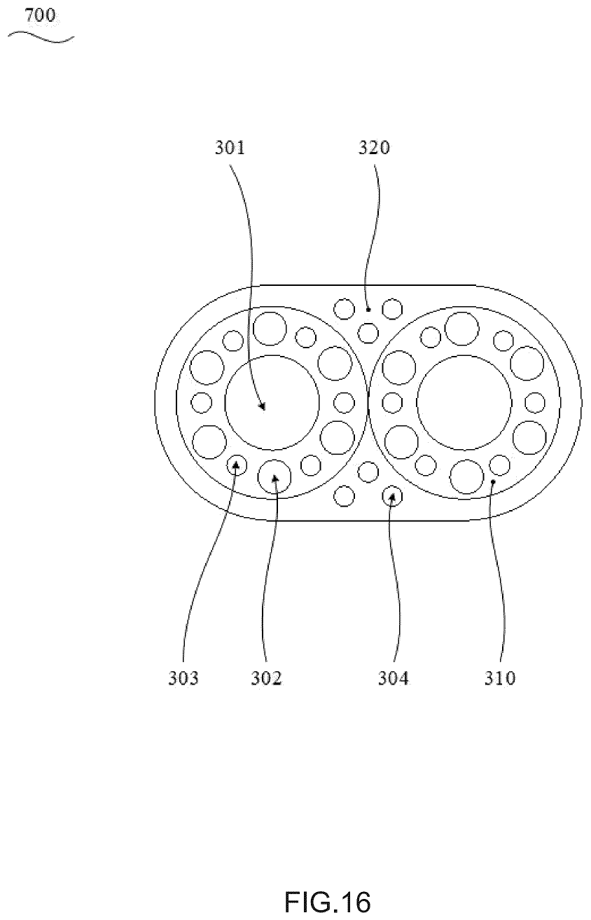

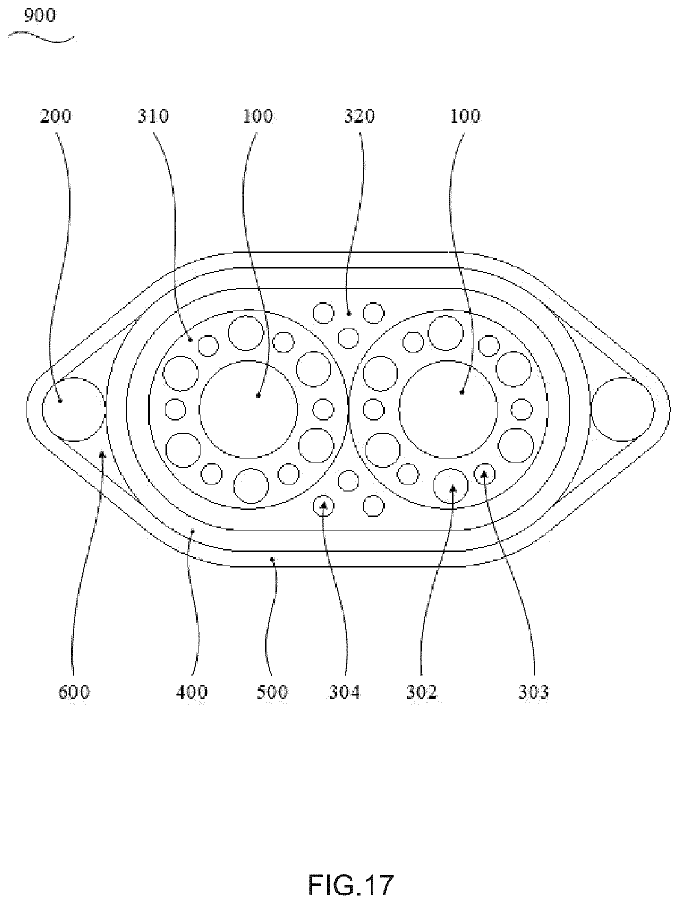

In one of the examples, the insulating medium structure 700 is shown in FIG. 16, and the high-speed cable 900 using the insulating medium structure 700 shown in FIG. 16 is shown in FIG. 17. Different from the examples shown in FIGS. 14 and 15, the second insulating medium 320 is further provided with the fourth pores 304, the passing areas of the fourth pores 304 are differently from those of the second pores 302, and each of the fourth pores 304 is arranged in an axially symmetric manner relative to the symmetry axis 800, that is, in this example, the first insulating medium 310 is provided with the second pores 302 and the third pores 303, and the second insulating medium 320 is provided with the fourth pores 304, the structural design ensures that the insulating medium structure 700 has sufficient structural strength, thereby guaranteeing the transmission performance of the wires when they are bent and twisted. Further, the air in the pores can be fully utilized as a transmission medium to reduce signal transmission loss and a degree of signal transmission attenuation, making it particularly suitable for long-distance transmission.

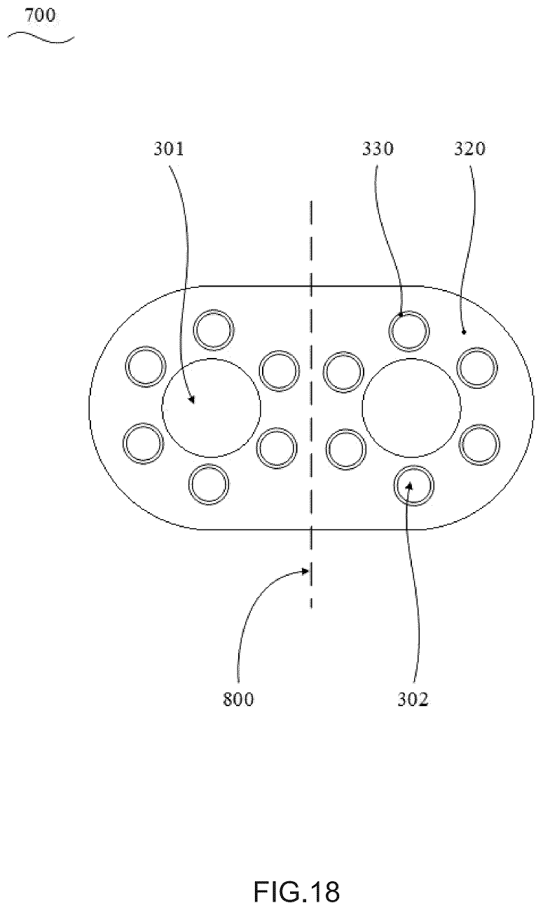

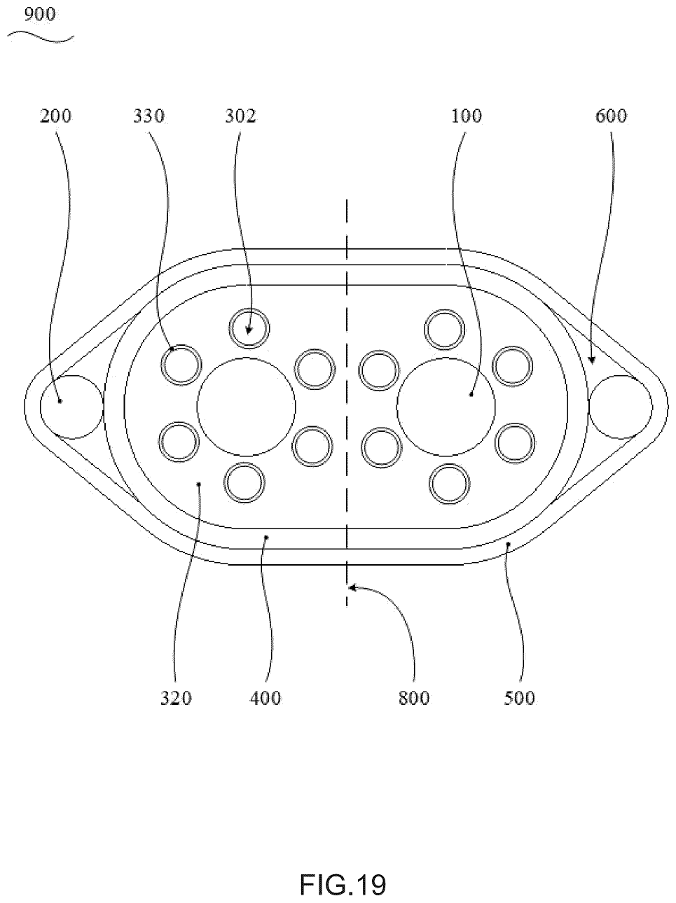

In order to improve the structural strength of the insulating medium structure 700 at the pores, in one of the examples, as shown in FIGS. 18 and 19, the insulating medium body 305 includes the second insulating medium 320 and the third insulating medium 330, the third insulating medium 330 is provided with the second pores 302, that is, the second pores 302 are located in the third insulating medium 330, that is, the second pores 302 are coated with the third insulating medium 330; and the other examples are analogous and will not be described in detail herein. Further, the second insulating medium 320 is completely applied over the third insulating medium 330 and outside the two first pores 301. Further, in one of the examples, material of the second insulating medium 320 is different from that of the third insulating medium 330. In this example, the insulating medium body 305 further includes the first insulating medium 310, each of the first pores 301 is coated with the first insulating medium 310; the first insulating medium 310 is completely applied over the third insulating medium 330 and outside the two first pores 301; and alternatively, the third insulating medium 330 is separated from the first insulating medium 310 by the second insulating medium 320. The structural design improves the structural strength at the second pores 302 to some extent, further avoiding the problem of performance variations in the high-speed cable 900 when it is bent and twisted, thereby ensuring the effectiveness of signal transmission of the high-speed cable 900 and further improving the effective transmission distance of the high-speed cable 900.

Further, in one of the examples, the third pores 303 and/or the fourth pores 304 are also located in the third insulating medium 330. This design improves the structural strength at the third pore 303 and/or the fourth pore 304, which is conducive to not only reducing the degree of transmission attenuation while reducing signal transmission loss, but also avoiding the problem of performance variations in the high-speed cable 900 when it is bent and twisted, thereby ensuring the effectiveness of signal transmission of the high-speed cable 900 and further improving the effective transmission distance of the high-speed cable 900.

It should be noted that other examples of the present disclosure also include an insulating medium structure and a high-speed cable that can be implemented by combining the technical features in the above examples. In each example, the insulating medium structure is applied in the high-speed cable; and in each example, the high-speed cable can also be referred to as a differential cable or a differential transmission cable.

Various technical features of the embodiments mentioned above may be arbitrarily combined. In order to simplify the description, all possible combinations of the various features of the embodiments mentioned above are not described. However, if only the combinations of these technical features do not conflict, they should be considered to be within the scope of description of the present disclosure.

The embodiments mentioned above are merely several embodiments of the present application, and are specifically described in details, but cannot be interpreted as limiting the scope of the patent for the invention as a result. It shall be noted that for those of ordinary skill in the field, they may make several transformations and improvements on the premise of not deviating from the conception of the present application, and these transformations and improvements shall fall within the scope of protection of the application. Hence, the scope of protection of the patent for the present application shall be subject to the appended claims.

1. An insulating medium structure, comprising:
an insulating medium body; and
pore formed in the insulating medium body; wherein
the pore comprises:
a first pore, with a number of a pair being formed in the insulating medium body and being arranged in an axially symmetric manner, and the pair of the first pores is used for passing a pair of conductors as a differential pair; and
a second pore, with a number of at least three being formed in the insulating medium body; and each of the second pores is arranged in an axially symmetric manner relative to a symmetry axis of the pair of the first pores.

2. The insulating medium structure according to claim 1, wherein each of the second pores is evenly divided into two groups, and each group of the second pores is symmetrically distributed with a center of the first pore as a center; or
each of the second pores is evenly divided into three groups, two groups of the second pores are symmetrically distributed with the center of the first pore as a center, and the other group of the second pores is arranged in an axially symmetric manner relative to the symmetry axis and/or evenly distributed on the symmetry axis; or
for the symmetry axis, the second pores located on the symmetry axis are arranged in an axially symmetric manner relative to the symmetry axis, and the second pores located on two sides of the symmetry axis are also arranged in an axially symmetric manner; or
cross sections of the second pores in an extension direction of the insulating medium body are partially or completely circular, partially or completely elliptical, partially or completely regular polygonal.

3. The insulating medium structure according to claim 1, wherein the insulating medium body is further provided with third pores, passing areas of the third pores are differently from those of the second pores, and each of the third pores is arranged in an axially symmetric manner relative to the symmetry axis.

4. The insulating medium structure according to claim 3, wherein the insulating medium body is further provided with fourth pores, passing areas of the fourth pores are differently from those of the second pores and those of the third pores, and each of the fourth pores is arranged in an axially symmetric manner relative to the symmetry axis.

5. The insulating medium structure according to claim 1, wherein the insulating medium body comprises a first insulating medium and a second insulating medium, each of the first pores is coated with the first insulating medium; and the two first insulating mediums are completely coated with the second insulating medium; and
the first insulating medium is provided with the second pores.

6. The insulating medium structure according to claim 5, comprising at least one of the following:
the second insulating medium is also provided with the second pores;
the first insulating medium is further provided with the third pores, passing areas of the third pores are differently from those of the second pores, and each of the third pores is arranged in an axially symmetric manner relative to the symmetry axis; and
the second insulating medium is further provided with the fourth pores, passing areas of the third pores are differently from those of the second pores, and each of the fourth pores is arranged in an axially symmetric manner relative to the symmetry axis.

7. The insulating medium structure according to claim 1, wherein the insulating medium body comprises the second insulating medium and a third insulating medium, and the third insulating medium is provided with the second pores; and
the second insulating medium is completely applied over the third insulating medium and outside the two first pores.

8. The insulating medium structure according to claim 7, wherein the insulating medium body further comprises the first insulating medium, and each of the first pores is coated with the first insulating medium; and
the first insulating medium is completely applied over the third insulating medium and outside the two first pores; and alternatively, the third insulating medium is separated from the first insulating medium by the second insulating medium.

9. The insulating medium structure according to claim 1, wherein the insulating medium body is arranged in an axially symmetric manner relative to the symmetry axis.

10. A high-speed cable, comprising conductors, ground wires, a shielding layer, an outer jacket, and the insulating medium structure according to claim 1, wherein
a pair of the conductors passes through a pair of first pores on the insulating medium structure in a one-to-one correspondence;
the insulating medium structure is coated with the shielding layer, and
the shielding layer and the ground wires are coated with the outer jacket.
